(19) United States
(12) Patent Application Publication
(10) Pub. No.: US 2018/0025294 A1
(43) Pub. Date: Jan. 25, 2018

(54) Route Reservation Method

(71) Applicant: BLUECARSHARING, Vaucresson (FR)

(72) Inventor: Guillaume Hugla, Paris (FR)

(73) Assignee: BLUECARSHARING, Vaucresson (FR)

(21) Appl. No.: 15/548,858

(22) PCT Filed: Jan. 28, 2016
(86) PCT No.: PCT/EP2016/051773

§ 371 Date: Aug. 4, 2017

(30) Foreign Application Priority Data
Feb. 9, 2015 (FR) 1551020

(51) Int. Cl. G06Q 10/02; G01C 21/34; G08G 1/00; G06Q 30/06

(52) U.S. Cl. CPC G06Q 10/02; G06Q 30/0645; G01C 21/3407; G08G 1/20

(57) ABSTRACT

The invention relates to a method (200) for reserving a journey, within the framework of an installation (100) for the automated rental of vehicles, in particular electric vehicles, comprising a plurality of sites (104), said method (100) comprising a step (202) of selecting an arrival position (322) automatically initiating the following steps:
automated determination (206) of a departure position;
automated identification (208) of a departure site that is the closest to the departure position; and
automated identification (210) of an arrival site that is the closest to the arrival position; and
   said method (200) also comprising a step (212) of storing at least one reservation data for said departure site (310) and at least one reservation data for said arrival site (324).

### CROSS-REFERENCE TO RELATED APPLICATIONS

This application is a national phase entry of International Application No. PCT/EP2016/051773, filed Jan. 28, 2016 and titled “Route Reservation Method,” which claims priority to and the benefit of French Patent Application No. 1551020, filed Feb. 9, 2015 and titled “Route Reservation Method.” The contents of the above-identified applications are relied upon and incorporated herein by reference in their entireties.

### FIELD OF THE INVENTION

The present invention relates to a method for reserving a journey, or trip, within the framework of an installation for the automated rental of a vehicle comprising a plurality of sites distributed over an area.

The field of the invention is the field of reserving a journey within the context of an installation for the automated rental of vehicles.

### STATE OF THE ART

Automated vehicle rental is a field experiencing rapid growth. In population centres where it is desirable to reduce the number of vehicles present in the area, automated vehicle rental systems are being established, such as for example for electric vehicles or bicycles.

These installations comprise rental sites distributed over an area making it possible to rent a vehicle or to return a vehicle at the end of rental. Now, as the capacity of each rental site is limited, it is not certain whether a particular rental site is available for renting a vehicle or returning a vehicle at the end of rental.

The actors in this field are now offering the option of reserving a journey carried out with a rented vehicle between a site called departure site, and a site called arrival site. Specifically, the user on the one hand reserves a vehicle at the departure site, and a parking space at the arrival site. This reservation option is offered either at one of the sites, or remotely through a smartphone app, for example, or through an internet page.

Now, reservation methods that are currently known require numerous interventions on the part of the user for indicating the place of departure, the place of arrival, selecting a site at the place of departure, at the place of arrival, confirming, etc., so that reserving a journey can be time-consuming, complex, not very ergonomic and sometimes discouraging for the user.

A purpose of the present invention is to overcome the aforementioned drawbacks.

A further purpose of the invention is to propose a method for reserving a journey that is simpler for the user to understand and use.

A further purpose of the invention is to propose a method for reserving a journey that is less time-consuming and allows a journey to be reserved more quickly.

Finally, a further purpose of the invention is to propose a method for reserving a journey that requires fewer interventions on the part of the user.

### DISCLOSURE OF THE INVENTION

The invention proposes to achieve at least one of the aforementioned aims by a method for reserving a journey, within the framework of an installation for the automated rental of vehicles, comprising a plurality of sites, each capable of being in an available or unavailable state, said method comprising a step of selecting an arrival position among at least one arrival position stored beforehand, said selection step automatically initiating the following steps:
automated determination of data relating to at least one position, called departure position;
automated identification as departure site, of an available site that is the closest to said departure position among said plurality of sites in order to rent a vehicle there; and
automated identification as arrival site, of an available site that is the closest to said arrival position among said plurality of sites in order to return a rented vehicle thereto; and
   said method also comprising a step of storing at least one reservation data for said departure site and at least one reservation data for said arrival site.

Thus, the method according to the invention can allow a journey to be reserved, with very little or no intervention on the part of the user, apart from the fact of launching the initiation of the method.

In any event, as the steps of determining the departure position, identifying the departure site and identifying the arrival site are initiated in an automated fashion following the selection step, no intervention by the user is required for these steps. The user may optionally intervene during the step of selecting the arrival position and/or for validating the storage step which confirms the reservation, which corresponds to a maximum of two interventions on the part of the user. As a result, the method according to the invention is simpler for the user to understand and use, and makes it possible to reduce the number of interventions on the part of a user and the time spent making the reservation.

Advantageously, the departure site can be identified depending on the one hand on location data of the sites and of the departure position, and on the other hand on at least one state data, called vehicle state data, indicating for each site the presence or absence at said site of an available vehicle.

Similarly, the arrival site can be identified depending on location data of the sites and on at least one state data, called parking space state data, indicating for each site the presence or absence at said site of an available parking space in order to return a vehicle thereto.

The method according to the invention can also comprise a step of storing location data relating to at least one arrival position, carried out prior to the selection step.

Such a storage step can be carried out before any reservation.

At least one arrival position can be stored locally at a user device carrying out the method according to the invention, or on a remote server forming part of the installation for the automated rental of vehicles.

The user may enter at least one arrival position:
by inputting data relating to said arrival position, for example using an alphanumeric keyboard;
by indicating a geographical position on an interactive map by pointing, through a touch screen or by moving a pointer;
by validating the location data supplied by a geolocation module when the arrival position that the user wishes to store corresponds to the current position of the user.

According to an embodiment, the arrival position can be selected manually by the user among several arrival positions for which information has been given beforehand.

According to a preferred embodiment, at least one arrival position can be displayed on a display screen, in particular a touch screen, of:
a fixed user device, such as a desktop computer,
a portable user device, such as a laptop computer, a smartphone, a tablet, a phablet, etc.,
a terminal or any device, private or public;
   for example in the form of a selection button representing, or associated with, said position or in a list, for example a dropdown or scrolling list.

In this case, at least one arrival position can be selected by pointing on said display screen, in particular by pointing, for example on a touch screen, on a selection button displayed on said screen and associated with said position.

According to another embodiment, the arrival position can be selected in an automated fashion depending on at least one predetermined parameter, and on a value of said parameter at the time of the reservation, the method also comprising a step of determining said value.

The arrival position can be selected depending, for example, on the time at which the user wishes to make the journey, in particular the time at which the reservation is made when the reservation relates to an immediate journey. For example, when the time of the journey corresponds approximately to a time at which the user leaves the office, then the arrival position for the reservation may correspond to his home location: the latter can then be selected in an automated fashion as the arrival position.

According to a preferred version of the method according to the invention, the departure position can correspond to the current position, the step of determining the departure position in an automated fashion can then comprise reading current location data supplied by a geolocation means, such as for example geolocation data supplied by a GPS module equipping a smartphone on which the method is executed.

Advantageously, the method according to the invention can also comprise displaying at least one departure position, stored beforehand, on a display screen, in particular a touch screen of:
a fixed user device, such as a desktop computer,
a portable user device, such as a laptop computer, a smartphone, a tablet, a phablet, etc.,
a terminal or any device, private or public;
in the form of a selection button representing, or associated with, said position or in a list or in a menu, in particular a dropdown or scrolling list.

Thus the departure position determined in an automated fashion can be modified by the user by pointing on said screen. This makes it possible for the user to select a departure position other than the one determined in an automated fashion, a new departure site then being identified in an automated fashion, in particular on the fly and/or in real time, with respect to the new departure position selected by the user.

When the method comprises selecting the arrival position, or the departure position, respectively, from a list or a menu, in particular scrolling, the position in said list or in said menu of at least one geographical position can be adjusted depending on the current geographical position or the current time.

For example, when the current geographical position corresponds to, or is close to, a business address, it is highly likely that the arrival position, or the departure position respectively, corresponds to this business address, or respectively to a private address for which information was given beforehand. This address can be moved higher up the list or the menu in order to make a quicker selection of the arrival position, or the departure position respectively.

According to another example, when the method is executed in the morning or in the evening respectively, it is highly likely that:
the arrival position corresponds to a business address, or respectively to a private address; and
the departure position corresponds to a private address, or respectively a business address.
   This address can be moved higher up the list or the menu in order to make its selection quicker.

Alternatively, a departure position can be determined automatically depending on the arrival position selected beforehand. For example, a departure position can be associated beforehand with an arrival position.

According to a particularly advantageous feature of the method according to the invention, the step of identifying the departure site and/or the step of identifying the arrival site can be carried out progressively in phases of increasing distance segments from the departure position, or the arrival position respectively.

For example, identifying the departure site, or the arrival site respectively, can be carried out among a first group of sites located at a distance of less than or equal to D with respect to the departure position or the arrival position respectively. When an available site with a vehicle available for rental is identified among the sites of this first group, then it is selected as departure site and it is not necessary to consult the other sites. Conversely, the step of identifying the departure site, or the arrival site respectively, takes account of a second group of sites located at a distance comprised between D and 2 D with respect to the departure position or the arrival position respectively, and so on.

Of course, the distance increment, i.e. the value D, can be fixed or variable at each iteration, identical or different for identifying the departure site and for identifying the arrival site.

In addition, the distance increment can be adjusted by the user or by a central site carrying out the management of the installation for the automated rental of vehicles, for identifying the departure site and/or for identifying the arrival site.

Thus, the method according to the invention makes it possible to identify the departure site, or the arrival site respectively, while taking less time and fewer resources with respect to a situation in which all of the sites are considered.

The storage step can comprise:
for the departure site, storing a user identification data in association with an identification data of a vehicle that is available at the departure site; and/or
for the arrival site, storing a user identification data in association with an identification data of a parking space that is available at the arrival site.

The data can be stored at the the departure site, or respectively the arrival site, or at a central site remote from said departure site and/or said arrival site.

In addition, data relating to at least one preference, and in particular to at least one preferential value of at least one parameter, can be stored at the level of the departure site, and/or the arrival site and/or the central site.

Alternatively or in addition, the data can be stored on a user device executing the reservation method.

Advantageously, the method according to the invention can also comprise a step of calculating a duration/distance of the journey in the vehicle between the departure site and the arrival site.

Thus, depending on the departure and arrival sites selected, the user can be informed as to the duration of the journey he has to carry out, which is more ergonomic.

Determining this journey duration, in addition to the distance separating said sites, takes account of traffic data on said journey supplied by a remote device.

Advantageously, the method according to the invention can also comprise moreover:
a step of calculating a duration/distance of the journey between the departure position and the departure site, in particular for a journey made on foot, and/or
a step of calculating a distance/duration of the journey between the arrival site and the arrival position, in particular for a journey made on foot.

The method according to the invention can also comprise a step of displaying, in a display window on a display screen of a user device, display data on at least one journey and/or at least one duration and/or of at least one distance relating to a journey between:
the departure site and the arrival site;
the departure position and the departure site; and/or
the arrival site and the arrival position.

The method according to the invention can also comprise displaying in a display window on a geographical map:
the departure position and the position of the departure site; and/or
the arrival position and the position of the arrival site.

Thus, the user is informed visually of the exact location on a map of at least one of these positions (of departure and of arrival) making it possible for the user to better orient himself in space throughout his movement between the departure position and the arrival position.

Preferentially, the method according to the invention can comprise simultaneously displaying in two display windows on a geographical map, in particular in two display windows arranged one below the other, of:
the departure position and the position of the departure site in the first of said two display windows; and
the arrival position and the position of the arrival site, in the second of said two display windows.

According to another aspect of the invention, a computer application is proposed for:
a portable device, in particular of the smartphone, tablet or phablet type, or
a fixed device, of the desktop computer or terminal type, private or public, comprising instructions that can be executed by said device in order to implement all the steps of the reservation method according to the invention, when said instructions are executed by said device.

### DESCRIPTION OF THE FIGURES AND EMBODIMENTS

Other advantages and characteristics will become apparent on examination of the detailed description of embodiments which are in no way limitative, and the attached drawings, in which:

FIG. 1 is a diagrammatic representation of an installation for the rental of a vehicle implementing the method according to the invention;

FIG. 2 is a diagrammatic representation in the form of a flowchart of an example of the method according to the invention; and

FIG. 3 is a diagrammatic representation of a display screen of a user device implementing the method in FIG. 2.

It is well understood that the embodiments which will be described below are in no way limitative. It is possible in particular to imagine variants of the invention comprising only a selection of features described below in isolation from the other features described, if this selection of features is sufficient to confer a technical advantage or to differentiate the invention with respect to the state of the prior art. This selection comprises at least one, preferably functional, characteristic without structural details, or with only a part of the structural details if this part alone is sufficient to confer a technical advantage or to differentiate the invention with respect to the state of the prior art.

In particular, all the variants and embodiments described can be combined together if there is no objection to this combination on technical grounds.

In the figures and in the remainder of the description, elements common to several figures retain the same reference.

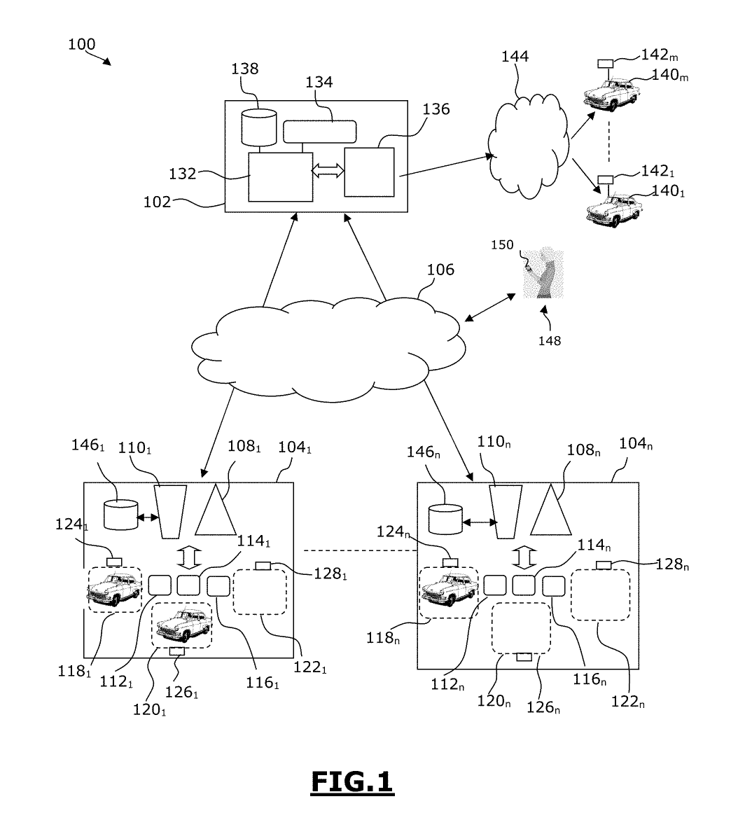

FIG. 1 is a diagrammatic representation of an installation for the automated rental of a electric vehicles in which the invention can be implemented.

The installation 100 shown in FIG. 1 comprises a central site 102 connected to several sites—or stations—104₁-104ₙ, called location stations, through a wireless communication network 106, for example GPRS, or a wired network, for example of the DSL or LAN type. Preferably, each site 104 is lined to the central site 102 via the two separate networks, which allows a continuous connection even if one of the networks fails.

Each rental site 104 comprises a rental terminal 110 for renting a vehicle and several charging terminals 112-116, each charging terminal being provided in order to charge a vehicle equipped with an electric battery at a parking space, namely the parking spaces 118-122.

Certain rental sites 104 also comprise a subscription terminal 108 for registering a new subscriber.

Each parking space of a rental site 104 comprises a presence detection module 124-128, namely weighing means, a camera and/or an infrared sensor and/or a detector of an electrical connection with a vehicle and/or a radar, connected to the rental terminal 110 of the rental site 104.

The central site 102 can be connected directly to each of the terminals of a rental site 104 through the network 106 or only to the subscription terminal and/or the rental terminal and/or to the charging terminals 112-116.

At least two terminals of a rental site are connected together through a wired connection (not shown).

The central site 102 comprises a central management server 132, a synthesis module 134 and a communication module 136, called central communication module.

The central site 102 also comprises a database 138 in which are recorded:
in association with the identifier of a vehicle offered for rental, the identifier of the user to whom the vehicle is rented/or for whom it is reserved; optionally the state (rented/free/under maintenance/reserved) for each vehicle,
in association with the identifier of a parking space 118-122, the identifier of the user for whom the parking space is reserved in order to return a vehicle thereto at the end of rental, optionally the state (reserved/occupied/free) for each parking space 118-122,
in association with an identifier of a station 104, the state of availability of this station,
in association with an identifier of a user, data representing at least one preferential value of a parameter associated with this user.

The central site 102 is in communication with electric vehicles 140₁-140ₘ during rental, via a central communication module 136 and a communication unit 142₁-142ₘ, called vehicle unit, arranged in each of the vehicles, through a wireless communication network 144, for example GPRS, which can be the same as the communication network 106.

By means of the central communication module 136 and the vehicle communication units 142, the central site 102 exchanges data with each of the vehicles 140.

Each vehicle communication unit 142 is in connection with a user interface (not shown) for example an interface of a vehicle geolocation unit, which may comprise a touch screen, for displaying data thereon on a map and for taking account of the data inputs carried out by the user of the vehicle 140.

Each rental station 104 comprises a database 146 in which the state, reserved or not, of each parking space 118-122 of the rental site 104 is recorded. This database 146 also stores the state of availability of each parking space, namely occupied or free.

A user 148 is able to interact with the installation 100, in particular with the remote site 102, and also more particularly with the server 132, via an application executed for example on a portable user device 150 of the smartphone type.

Of course, alternatively or in addition, it is also possible for the user to interact with the installation 100 through a desktop computer or any fixed or mobile device that is capable of being connected to a given communication network.

A user 148 is able to interact with the installation 100, in particular with the remote site 102, and also more particularly with the server 132, via:
a terminal at a rental station, and in particular the rental terminal 108,
the user interface of each vehicle 140, and/or
an application executed for example on a portable user device 150 of the smartphone type.

As a result, the method according to the invention, and in particular the embodiments described below can be equally well implemented at a rental site, in a vehicle or also through the device 150.

However, for reasons of clarity, the examples described hereinafter are assumed to be carried out through a portable user device such as the device 150.

In an installation for the automated rental of vehicles, at least two data are associated with each site:
a state data, called vehicle state data, indicating the availability or not of a site for renting a vehicle: the site is available if there is at least one vehicle available for rental, and not available otherwise; and
a state data, called parking space state data, indicating the availability or not of a site for returning a vehicle at the end of rental: the site is available if there is at least one parking space available for returning the vehicle thereto, and not available otherwise.

As a result, during identification of a departure site, the state data taken into account in order to determine the availability or not of a site is the vehicle state data, and during the identification of an arrival site, the data taken into account in order to determine the availability or not of a site is the parking space state data.

Each state data can be a binary data, for example 1 for available and 0 for not available. Alternatively, each state data can be a data that is capable of adopting several values, in particular the number of available vehicles for the vehicle state data, and the number of available parking spaces for the parking space data.

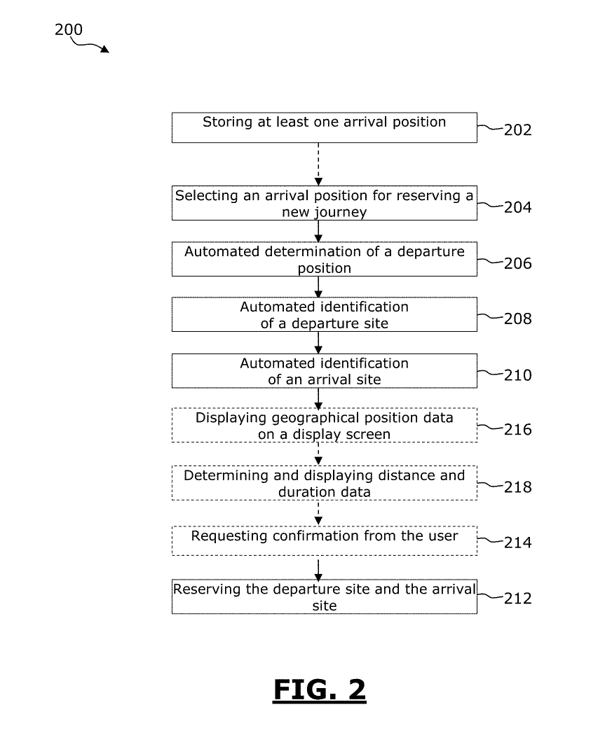

FIG. 2 is a diagrammatic representation in the form of a flowchart of an example of the method according to the invention.

The method 200 shown in FIG. 2 comprises a step 202, prior to reserving a journey, and allowing a user to store data relating to at least one position, called arrival position. During this step, the user can enter one or more arrival positions:
by inputting data relating to said arrival position, for example using an alphanumeric keyboard of a portable user device, such as a smartphone;
by indicating a position on an interactive map, displayed on a display screen of a portable user device, such as a smartphone, by pointing, through a touch screen or by moving a pointer on said screen;
by validating the position data supplied by a module of a portable user device, such as a smartphone, when the arrival position that the user wishes to store corresponds to a current position of the user.

Step 202 can be repeated as many times as necessary in order to enter as many arrival positions as the user wishes to store.

During a step 204, carried out straight after the storage step 202 or not, an arrival position is selected with a view to reserving a new journey. The arrival position can be selected in different ways during step 204:
by manual selection, by touch or not, by the user among several arrival positions displayed on a display screen, for example through a button associated with said arrival position and displayed on a display screen, or
in an automated fashion depending for example on the time.
   In the example described, selection of the arrival position is carried out by touch selection on a touch display screen of a control button associated with said arrival position.

During step 206, a departure position is determined in an automated fashion. The departure position can correspond to the current position of the user. In this case, the step of determining the departure position comprises reading geographical location data supplied by a GPS module of a user device carried by the user, such as a smartphone.

Alternatively, a departure position can be determined automatically depending on the arrival position selected beforehand during step 204.

The method 200 also comprises a step 208 identifying a departure site in an automated fashion depending on the departure position, and for each of the sites of the installation:
data of the geographical position of said site, and
a vehicle data associated with said site, and indicating for said site the availability or not in said site of a vehicle available for rental.

Step 208 carries out the identification of the departure site by consulting the sites of the installation by iteration based on a distance criterion with respect to the departure position. The vehicle availability data relating to a first group of sites located at a distance of less than or equal to D1 with respect to the departure position are loaded. Starting with the site that is the closest to the departure position, the availability of each site in the first group is tested. The first site identified as available is selected as departure site and step 208 stops. If the first group does not contain any available site, the vehicle availability data relating to a second group of sites located at a distance comprised between D1 and 2 D1 with respect to the departure position are loaded, then tested, and so on.

The method 200 also comprises a step 210 identifying a departure site in an automated fashion depending on the arrival position, and for each of the sites of the installation:
data on the geographical position of said site, and
a parking space data associated with said site, and indicating for said site the availability or not in said site of an available parking space for returning the vehicle thereto at the end of rental.

Step 210 carries out the identification of the arrival site by consulting the sites of the installation by iteration based on a distance criterion with respect to the arrival position. The vehicle availability data relating to a first group of sites located at a distance less than or equal to D2 with respect to the arrival position are loaded. Starting with the site that is the closest to the arrival position, the availability of each site in the first group is tested. The first site identified as available is selected as arrival site and step 210 stops. If the first group does not contain any available site, the parking space availability data relating to a second group of sites located at a distance comprised between D2 and 2 D2 with respect to the arrival position are loaded, then tested, and so on.

In the present example D1=D2.

In the example described, step 210 of automated identification of an arrival site is carried out after step 208 of automated identification of a departure site. Of course, this step 210 can be carried out before step 208, and even before step 206 of automated determination of the departure position.

The method 200 also comprises a step 212 of reserving departure and arrival sites. To this end, a user identification data is stored:
in association with an identification data of a vehicle that is available at the departure site, for reserving said departure site;
in association with an identification data of a parking space that is available at the arrival site, for reserving said arrival site;

For at least one of said sites, the identification data can be stored in a database located at said site, or on a remote site linked to said site through a communication network.

The method 200 can also comprise an optional step 214, carried out just before the reservation step 212, and requesting a confirmation from the user before the reservation.

An optional step 216, carried out after step 210, can produce a display, on a display screen, of the geographical locations of the departure and arrival sites, as well as the geographical location of the departure position and the geographical location of the arrival position, for example in two display windows located one above the other.

Furthermore, the method 200 can comprise an optional step 218, carried out after, during, or at the same time as the optional step 216, and producing a calculation and a display of:
a journey distance and/or duration, in particular carried out on foot, between the departure position and the departure site;
a journey distance and/or duration, in particular carried out on foot, between the arrival site position and the arrival position.
a journey distance and/or duration, carried out with the rented vehicle, between the departure site and the arrival site;

According to the invention, steps 206-210 (and optionally steps 212, 216 and 218) are initiated automatically as soon as step 204 of selecting the arrival position has finished, without intervention on the part of the user.

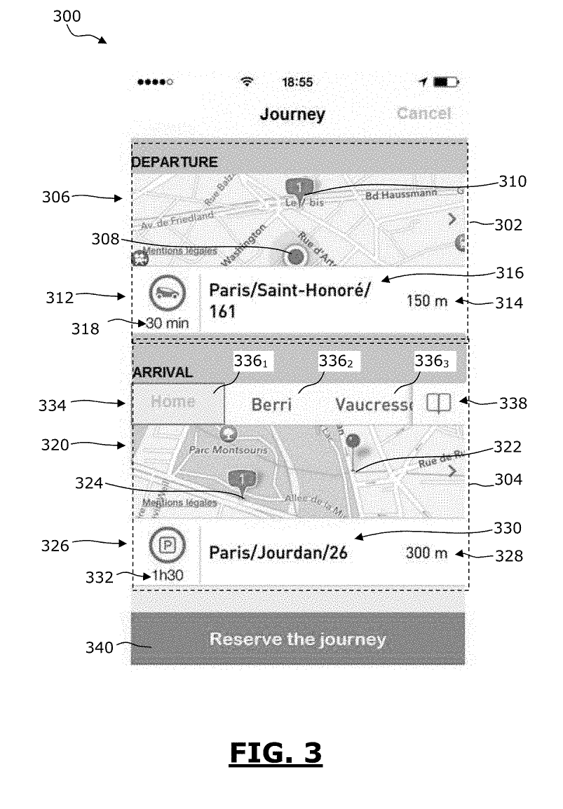

FIG. 3 is a diagrammatic representation of a display screen, in particular a touch screen, of a portable user device used for implementing the method 200 in FIG. 2, such as a smartphone or a computer, and more generally, any device that is able to connect to a given network.

FIG. 3 shows more particularly, the display screen of the device obtained after step 214, just before the reservation step 212 is carried out, in the method 200 in FIG. 2.

Thus, the display screen 300 comprises two display windows, respectively 302 and 304. The display window 302 is arranged above the display window 304.

The display window 302 comprises a display area 306 displaying on a geographical map the departure position 308 and the location of the departure site 310. The location of the departure site 310 is shown by a symbol also comprising a value, namely in the example the figure “1”, showing the number of vehicles available at the departure site. The display window 302 comprises, below the display area 306, a display area 312 displaying the distance 314 separating the departure position 308 and the departure site 310, the name 316 of the departure site 310, as well as the remaining duration 318 of reservation of the reserved vehicle at the departure site 310.

The display window 304 comprises a display area 320 displaying on a geographical map the arrival position 322 and the location of the arrival site 324. The location of the arrival site 324 is shown by a symbol also comprising a value, namely in the example the figure “1”, showing the number of parking spaces available at the arrival site 324. The display window 304 comprises, below the display area 320, a display area 326 displaying the distance 328 separating the arrival site 324 from the arrival position 322, the name 330 of the departure site 324, as well as the remaining duration 332 of reservation of the reserved parking space at the arrival site 324.

The display window 304 also comprises a display area 334 positioned between the display area 320 and the display area 312. This display area 334 comprises a set of several selection buttons 336₁-336₃ that can be scrolled sideways. Each selection button 336 is associated with an arrival position, stored beforehand by the user, and makes it possible to select an arrival position, for example during step 204 of the method 200. A button 338 makes it possible to access one or more lists comprising other arrival positions.

Finally, the display screen 300 comprises a reservation confirmation button 340.

Of course, the invention is not limited to the examples which have just been described.

1) A method (200) for reserving a journey, within the context of an installation (100) for the automated rental of vehicles, comprising a plurality of sites (104), each capable of being in an available or unavailable state, said method (100) comprising a step (202) of selecting an arrival position (322) among at least one arrival position stored beforehand, said selection step (202) automatically initiating the following steps:
automated determination (206) of data relating to at least one position (308), called departure position;
automated identification (208) as departure site (310), of an available site that is the closest to said departure position among said plurality of sites in order to rent a vehicle there; and
automated identification (210) as arrival site (324), of an available site that is the closest to said arrival position (322) among said plurality of sites in order to return a rented vehicle thereto; and
said method (200) also comprising a step (212) of storing at least one reservation data for said departure site (310) and at least one reservation data for said arrival site (324).

2) The method (200) according to claim 1, characterized in that it comprises a step (202) of storing location data relating to at least one arrival position, carried out prior to the selection step (204).

3) The method (200) according to claim 1, characterized in that the arrival position is selected manually by the user.

4) The method (200) according to claim 3, characterized in that it comprises a display of at least one arrival position (332) on a display screen (300), in particular on a touch screen, of:
a fixed user device, such as a desktop computer,
a portable user device, such as a laptop computer, a smartphone, a tablet, a phablet, etc.,
a terminal or any device, personal or public;
the selection of the arrival position (322) being carried out by pointing, in particular by touch, on said screen (300).

5) The method (300) according to claim 3, characterized in that at least one arrival position (322) is displayed in the form of a selection button (336) representing, or associated with, said position or in a list or in a menu, in particular a dropdown or scrolling list.

6) The method (300) according to claim 1, characterized in that the arrival position (322) is selected in an automated fashion depending on at least one predetermined parameter, and on a value of said parameter at the time of the reservation, in particular the current time, said method (200) also comprising a step of determining said value.

7) The method (200) according to claim 1, characterized in that the departure position (308) corresponds to the current position, the step (206) of determining the departure position in an automated fashion (308) comprising reading current location data supplied by a geolocation means.

8) The method according to claim 1, characterized in that it comprises a display of at least one departure position, stored beforehand, on a display screen, in particular a touch screen, of:
a fixed user device, such as a desktop computer,
a portable user device, such as a laptop computer, a smartphone, a tablet, a phablet, etc.,
a terminal or any device, personal or public;
in the form of a selection button representing, or associated with, said position or in a list or in a menu, in particular a dropdown or scrolling list, such that the departure position determined in an automated fashion can be modified by the user by pointing on said screen.

9) The method (200) according to claim 1, characterized in that step (208) of identifying the departure site (310), respectively step (210) of identifying the arrival site (324), can be carried out progressively in (a) phase(s) of increasing distance segments from the departure position (308), or the arrival position (322) respectively.

10) The method (200) according to claim 1, characterized in that the storage step (212) comprises:
for the departure site (310), storing a user identification data in association with an identification data of a vehicle that is available at said departure site (310); and/or
for the arrival site, storing a user identification data in association with an identification data of a parking space that is available at said arrival site (324).

11) The method (200) according to claim 1, characterized in that it also comprises a step (218) of calculating a vehicle journey duration/distance between said departure site (310) and said arrival site (324).

12) The method (200) according to claim 1, characterized in that it also comprises:
a step (218) of calculating a journey duration/distance between the departure position (308) and the departure site (310), and/or
a step (218) of calculating a journey distance/duration between the arrival site (324) and the arrival position (322).

13) The method (200) according to claim 1, characterized in that it comprises a display (216, 218), in a display window (302, 304) on a display screen (300) of a user device, of display data of at least one journey and/or at least one duration and/or at least one distance relating to a journey between:
the departure site (310) and the arrival site (324);
the departure position (308) and the departure site (310); and/or
the arrival site (324) and the arrival position (322).

14) The method (200) according to claim 1, characterized in that it also comprises a display (216) in a display window (302, 304) on a geographical map, of:
the departure position (308) and the position of the departure site (310); and/or
the arrival position (322) and the position of the arrival site (324).

15) The method (200) according to claim 14, characterized in that it comprises a simultaneous display (216) in two display windows (302, 304) on a geographical map, in particular on two display windows (302, 304) arranged one below the other, of:
the departure position (308) and the position of the departure site (310) in the first (302) of said two display windows (302, 304); and
the arrival position (322) and the position of the arrival site (324), in the second (304) of said two display windows (302, 304).

16) The method (200) according to claim 1, further comprising:
a computer application for:
a portable device (150), in particular of the smartphone, tablet or phablet type, or
a fixed device, of the desktop computer or terminal type,
private or public, comprising the instructions that can be executed by said device (150) in order to implement all the steps of the method (200).

17) The method (200) according to claim 1, wherein the step (202) of selecting an arrival position (322) further comprises a step selected from the group consisting of:
inputting data relative to said arrival position (322) with an alphanumeric keyboard;
indicating a geographical position by moving a pointer; and
validating the location data supplied by a geolocation module when the arrival position that the user wishes to store corresponds to the current position of the user.

18) A method (200) for reserving a journey, within the context of an installation (100) for the automated rental of vehicles, comprising a plurality of sites (104), each capable of being in an available or unavailable state, said method (100) comprising a step (202) of selecting an arrival position (322) among at least one arrival position stored beforehand, said selection step (202) automatically initiating the following steps:
automated determination (206) of data relating to at least one position (308), called departure position;
communicating with a plurality of vehicles (140) through a communication unit (142);
assessing the status of each of said plurality of vehicles (140) based on a vehicle state data communicated through said communication unit (142)
determining an availability of each of said plurality of vehicles (140) at each of said plurality of sites (104);
automated identification (210) as arrival site (324), of an available site that is the closest to said arrival position (322) among said plurality of sites in order to return a rented vehicle thereto;
said method (200) also comprising a step (212) of storing at least one reservation data for said departure site (310) and at least one reservation data for said arrival site (324).

19) The method (200) according to claim 18, wherein the step of identifying (210) said arrival site (324) further comprises the steps of:
determining a distance (D1) between a first group of said plurality of sites (104) and said arrival position (322);
determining a distance (D2) between a second group of said plurality of sites (104) and said arrival position (322);
comparing each of D1 and D2 with said arrival position (322);
obtaining a parking space data from said first group of said plurality of sites (104) if D1 is less than D2;
assessing an availability of a parking space within said first group of said plurality of sites (104); and
selecting said arrival position (322) if said first group of said plurality of sites (104) includes said available parking space.

20) A method (200) for reserving a journey, within the context of an installation (100) for the automated rental of vehicles, comprising a plurality of sites (104), each capable of being in an available or unavailable state, said method (100) comprising a step (202) of selecting an arrival position (322) among at least one arrival position stored beforehand, said selection step (202) automatically initiating the following steps:
automated determination (206) of data relating to at least one position (308), called departure position;
obtaining geographic data of any number of a plurality of departure sites (310);
obtaining vehicle data associated with each of said plurality of departure sites (310);
assessing an availability of a vehicle at each of said plurality of departure sites (310);
calculating a distance between each of said plurality of departure sites (310) having at least one available vehicle with a departure location;
identifying (208) the departure site (310) having the shortest distance between said departure site (310) and said departure location;
automated identification (210) as arrival site (324), of an available site that is the closest to said arrival position (322) among said plurality of sites in order to return a rented vehicle thereto;
said method (200) also comprising a step (212) of storing at least one reservation data for said departure site (310) and at least one reservation data for said arrival site (324).
